(19) United States
(12) Patent Application Publication
(10) Pub. No.: US 2002/0116353 A1
(43) Pub. Date: Aug. 22, 2002

(54) Natural bibliographic linking system

(76) Inventor: William E. Guerra, Falls Church, VA (US)

Correspondence Address: WILLIAM E. GUERRA, 7751 TREVINO LANE, FALLS CHURCH, VA, 22034, US

(21) Appl. No.: 10/067,906

(22) Filed: Feb. 8, 2002

Related U.S. Application Data
(60) Provisional application No. 60/268,721, filed on Feb. 15, 2001.

(51) Int. Cl. G06F 17/00

(52) U.S. Cl. 706/45; 707/100

(57) ABSTRACT

The Natural Bibliographic Linking System or “Nat Link” invention—for which I am herewith requesting a patent—is characterized for being a natural and exhaustive system of bibliographic linking and also the most simple, objective, integrated, accurate and expeditious system of dealing with the universe of knowledge and information. It is also characterized for empowering end-users and scholars to service themselves, as never before.

The Natural Bibliographic Linking System or “NAT-LINK” invention can then be defined as the automated system, whose way of linking Knowledge and information is meant to be natural or close to reality as much as possible; and it is also the most simple, direct and fluid system of handling the universe of knowledge and information; and in general of dealing with both digital and non digital resources.

### CROSS REFERENCE TO RELATED APPLICATIONS

Not applicable

### STATEMENT REGARDING FED SPONSORED R. or D

Not applicable

### REFERENCE TO SEQUENCE LINKING

Not applicable

### BACKGROUND OF THE INVENTION

There are currently various world-wide known schemes of bibliographic control and management, and in general many ways of dealing with knowledge and information. But there is also great contradiction and inconsistency, because of limitations inherent to such disparate approaches, which have been arbitrarily or artificially imposed and are now currently in practice. This enhance and complicate unnecessarily the work, in an environment which is already exceptionally complex by nature.

### BRIEF SUMMARY OF THE INVENTION

The Natural Bibliographic Linking System or “Nat-Link” invention—for which I am herewith requesting a patent—is characterized for being a natural and exhaustive system of bibliographic linking, and the most simple, objective, accurate, and expeditious way of dealing with the universe of knowledge and information; as well as of empowering end-users and scholars to service themselves, as never before.

As never before the universe of Knowledge and Information is handled by the “Nat-Link” invention in a natural and integrated way; thus having solved the challenge and contradictions resulting from current disparate schemes which have been arbitrarily or empirically imposed.

### DETAILED DESCRIPTION

The universe of knowledge and information may be classified and managed according to many ways, systems, fashions and options, but there is only one natural way, the one which is hereby being named the Natural Bibliographic Linking System or just “Nat-Link” for the Web and other resources; a system for which I am hereby requesting a patent, claiming that with the “Nat-Link” system, knowledge and information can be systematically, consistently and precisely managed faster than ever.

It happens that bibliographic organization and management is now based in a an inconsistent and cumbersome methodology, which is in fact wrong, almost like in an intentional “built in error”, which in turn causes that the linking work is not only subjective and inconsistent but unnecessarily enhanced and complicate. Such current approach and methodology is characterized by the proliferation of all sorts of contradictory schemes, tools and options for discovery and retrieval of Web resources, including those related to usability and poorly designed Web sites; as well as by descriptive work, which is also inconsistent, repetitive and unnecessarily detailed work, but above all too slow to handle the complexity of Web resources.

Such current methodology requires of course of too much expertise and time, both of which are expensive; a highly costly methodology indeed, which lacks unity and integrity being based in many options, many of them contradictory or incongruent options and consequent overlapping, on which such kind of labor-intensive methodologies are based; to say nothing of the time which is unnecessarily lost by the end-user or the scholar, both of them being now almost entirely dependent on others.

In the Nat-Link system, on the other hand, the universe of Knowledge and information is managed and handled in a natural, direct, coherent, systematic and integrated way, as never before; a proven methodology which is exclusive of the Nat-Link system, that not only gives due consideration to adequate collocation, but above all in that classes or subject categories merge naturally and gradually. Handling Web resources and others with the Nat-link system is thus both objective and expeditious, and also the easiest way at lowest cost, precisely because it is a natural system and therefore an easy to deal with system, but it is above all a fully accurate system.

There is no room for subjectivity in the Nat-Link system, because almost everything is organized in advance, and any error can be objectively detected and corrected openly because it is a self service work; but is the exhaustive and at the same time simple way how the linking is done, what mostly characterizes the Nat-Link system; thus overcoming the limitations inherent to current systems which are not exhaustive, while the Nat-Link system is specially concerned with accurate work but at the same time so practical that is a self service work as pointed out above. As never before end-users and scholars are empowered to services themselves with the Nat-Link system.

1. “The Natural Bibliographic Linking System” or “Nat-Link” invention is basically characterized for being a natural system and at the same time the most simple, objective, accurate and expeditious way of linking knowledge and information.

2. The “Nat-Link” system is not just a natural system and therefore an easy to deal with system, but is above all an exhaustive and integrated system, in contrast with the many contradictory approaches that are now being used in dealing with knowledge and information.

3. The “Nat-Link” system empowers end-users and scholars to service themselves, as never before.
